(19) United States
(12) Patent Application Publication
(10) Pub. No.: US 2026/0369973 A1
(43) Pub. Date: Nov. 19, 2026

(54) EMERGENCY POWER SHUTDOWN MANAGEMENT SYSTEM

(71) Applicant: Fike Corporation, Blue Springs, MO (US)

(72) Inventors: Christopher Dean Roark, Pleasanton, CA (US); James B. Zaboski, Pleasanton, CA (US)

(21) Appl. No.: 19/678,492

(22) Filed: May 15, 2026

Related U.S. Application Data
(60) Provisional application No. 63/806,799, filed on May 16, 2025.

(51) Int. Cl. H02B 15/00; G08B 17/10; H02H 1/00

(52) U.S. Cl. CPC H02B 15/00; G08B 17/10; H02H 1/0007

(57) ABSTRACT

A power shut-down management system includes sets of relays coupled to different types of equipment, a cabinet, a touchscreen display, and a programmable logic controller. The cabinet houses the sets of relays and the programmable logic controller. The touchscreen display is positioned on the cabinet. The programmable logic controller housed in the cabinet and in communication with the touchscreen display. The programmable logic controller is programmed to display on the touchscreen display an alarm indicator for indicating activation of an alarm, a system discharge indicator, and emergency power off indicators for indicating an emergency power off situation in one of a plurality of zones. The programmable logic controller is also programmed to activate the different sets of relays based upon input signals from different sources so that the different types of equipment can be shut based on the input signal received.

### RELATED APPLICATION

This Application claims the benefit of U.S. Provisional Patent Application No. 63/806,799, filed May 16, 2025, which is incorporated by reference herein in its entirety.

### BACKGROUND OF THE INVENTION

Emergency power off (EPO) installation is often an afterthought in construction. Current EPO installations are designed, installed and tested in the field at the end of a project, simply to meet minimum code requirements. Often construction documents do not include detailed specifications, standards for quality, wiring schematics or desired sequence of operation. Consequently, most EPO installations end up as decentralized, independent mechanisms—usually comprised of relays located in junction boxes scattered about the room, access floor and/or above ceilings. Each individual piece of equipment may have to be shut down separately—virtually impossible in times of emergency. In addition, power to the EPO control is not easily identified or monitored; wiring diagrams are often not available; and no maintenance bypass switch is installed that would enable the user to lock out EPO activation during routine maintenance. These installations are not easily modified or expanded and are susceptible to disruptive and potentially costly inadvertent shutdowns.

Thus, there is a need for an improved EPO installation. This background discussion is intended to provide information related to the present invention which is not necessarily prior art.

### SUMMARY OF THE INVENTION

Embodiments of the current invention address one or more of the above-mentioned problems and provide a distinct advance in the art of power shut-down management systems and methods of controlling shut down of equipment.

A power shut-down management system constructed according to an embodiment of the invention includes alarm equipment relays, system discharge relays, shunt trip relays, a cabinet, a touchscreen display, and a programmable logic controller. The alarm equipment relays are coupled with a first set of equipment. The system discharge relays are coupled with a second set of equipment. The shunt trip relays are coupled with a third set of equipment. The cabinet houses the alarm equipment relays, the system discharge relays, and the shunt trip relays. The touchscreen display is positioned on the cabinet.

The programmable logic controller is housed in the cabinet and is in communication with the touchscreen display. The programmable logic controller is programmed to display on the touchscreen display an alarm indicator for indicating activation of an alarm, a system discharge indicator for indicating a discharge of fire or explosion suppression agents, and emergency power off indicators for indicating an emergency power off situation in one or more zones; activate the alarm indicator and the alarm equipment relays upon receipt of a signal representative of an alarm signal from a fire control panel to indicate the activation of the alarm and to shut down the first set of equipment; activate the system discharge indicator and the system discharge relays upon receipt of a system discharge signal from the fire control panel to indicate the discharge of fire or explosion suppression agents and to shut down the second set of equipment; and activate the emergency power off indicators, the alarm equipment relays, the system discharge relays, and the shunt trip relays upon receipt of an emergency power off signal from one or more emergency power off switches to indicate the emergency power off situation and to shut down the first, second, and third sets of equipment.

By controlling the several relays by the programmable logic controller, controls are consolidated in one location. Additionally, it enables the use of one or more memory elements to record event history for all critical system functions, troubles, and alarms. It also enables the implementation of a maintenance bypass mode with lockout to prevent accidental activation of emergency power off when removing the system from override mode. Additionally, the programmable logic controller is programmed to implement staged activation of critical power and HVAC and other mechanical system shutdown. Embodiments also enable thorough documentation and sequence of operation. The touchscreen display enables clear signage and drawings of the entire control system. It also enables local monitoring and display of functions. One or more embodiments may include dual action locking-type EPO switches with protective flip-up covers. In one or more embodiments, the programmable logic controller also enables remote monitoring of relays of critical functions. In one or more embodiments, power to the system can be monitored by a fire control panel, as required by NFPA 75. The touchscreen display further enables modularity so that the system can be modified or expanded, such as to include additional connections to emergency power off switches of different zones.

Another embodiment of the invention is a method of controlling a shutdown of first, second, and third sets of equipment. The method includes receiving, via a programmable logic controller of a power shut-down management system, an emergency power off signal from one or more emergency power off switches to indicate an emergency power off situation; displaying, via a touchscreen display attached to a cabinet of the power shut-down management system and in communication with the programmable logic controller, an emergency power off indictor representative of the emergency power off switch from which the signal was received; delaying, via the programmable logic controller, a predefined amount of time; and activating, via the programmable logic controller, alarm equipment relays coupled with the first set of equipment, system discharge relays coupled with the second set of equipment, and shunt trip relays coupled with the third set of equipment to shut down the first, second, and third sets of equipment.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is an elevational view of an emergency power shutdown management system constructed in accordance with a preferred embodiment of the present invention;

FIG. 2 is a perspective view of the emergency power shutdown management system of FIG. 1 with its front door opened to show internal components;

FIG. 3 is a schematic diagram of the emergency power shutdown management system of FIG. 1 shown operatively coupled with various input signal sources and controlled devices;

FIGS. 4-13 are graphical user interfaces of a display of the emergency power shutdown management system of FIG. 1 showing various indicators and inputs; and

FIG. 14 is a flowchart depicting exemplary steps of a method according to an embodiment of the present invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

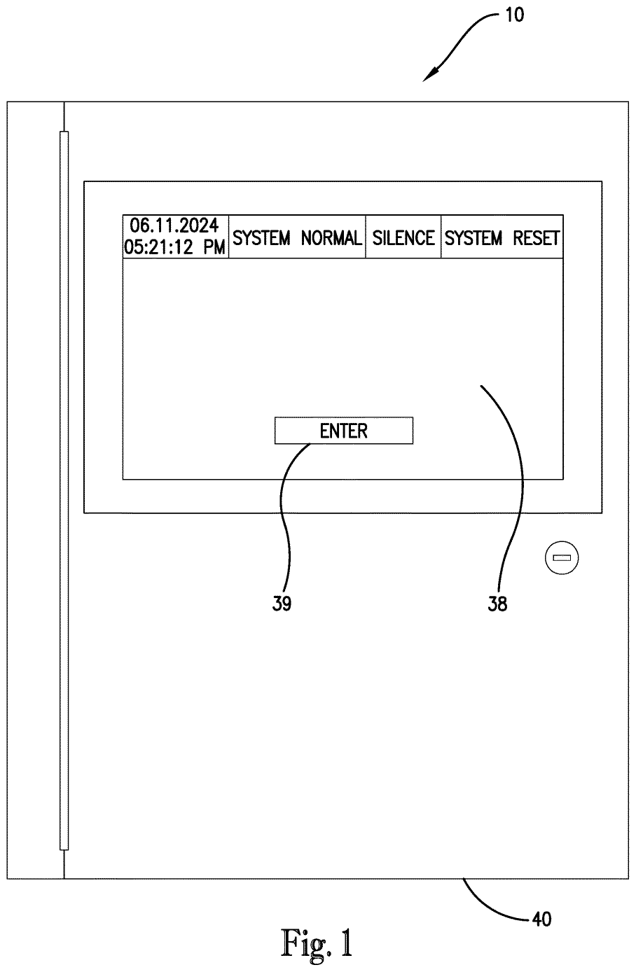

An emergency power shutdown management system (EPSMS) 10 constructed in accordance with a preferred embodiment of the present invention is shown in the drawing figures. As best illustrated in FIG. 1, the EPSMS 10 includes a touchscreen display 38 for indicating the status of the EPSMS 10 and the controlled equipment. The touchscreen display 38 is operable to display one or more control buttons or switches 39 for controlling certain functions of the EPSMS 10. The display 38 is preferably an HMI/PLC Eaton touch screen display, such as Eaton's Moeller series XV100 or XV300. However, other types of touch screen displays may be used without departing from the scope of the present invention. These components are all conveniently housed within a single cabinet or enclosure 40 for consolidating the shutdown of the controlled equipment. The enclosure 40 is preferably a NEMA-1 rated enclosure capable of being surface or flush mounted with a swing door and key lock. The enclosure may be constructed of any suitable material such as 18-gauge or greater steel and may be powder coated black inside and out. All components of the EPSMS 10 are preferably furnished in one enclosure.

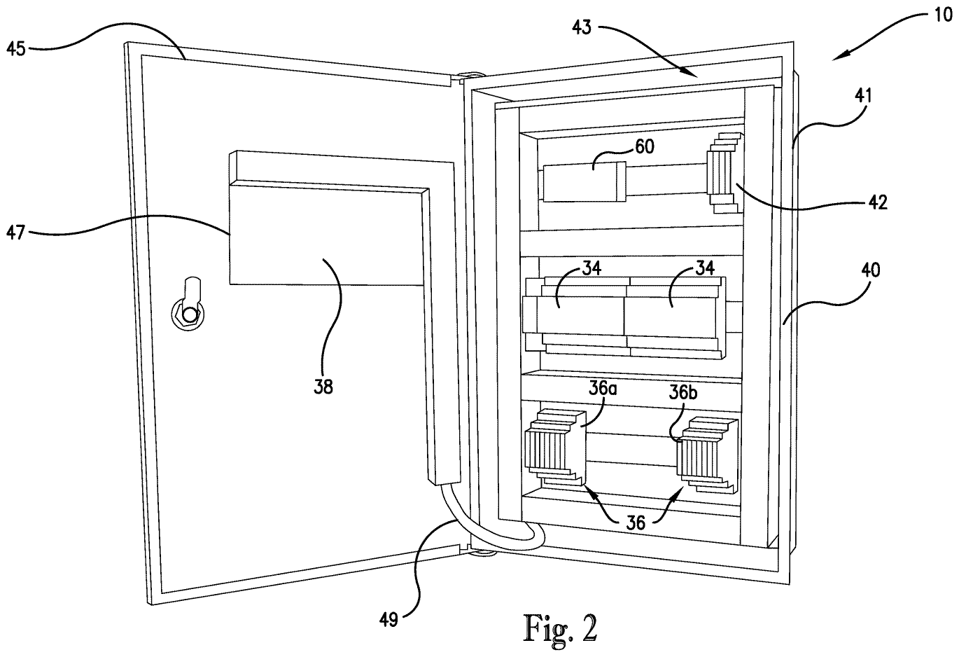

As best illustrated in FIG. 2, the EPSMS 10 includes one or more programmable logic controllers (PLCs) 34 or other computing devices for communicating with the touchscreen display 38, receiving the input signals from external sources, such as a fire control panel, emergency power off (EPO) switches or any other input signal sources, and/or the like. The PLCs 34 may be Cutler-Hammer Eaton EZ intelligent relay EZ 719-AC-RCX devices or any equivalent device. The PLCs may also be replaced with other computing or logic devices.

The EPSMS 10 also includes a plurality of relays 36 coupled between the outputs of the PLC 34 and the controlled equipment for shutting down the controlled equipment. The EPSMS 10 also preferably includes a system trouble relay 60 which is activated when in a maintenance override mode to send an appropriate warning signal to an outside or remote monitoring station and/or a maintenance notification beacon. The system trouble relay is also activated if the EPSMS is disconnected from power. The relays 36 may be any conventional relays such as N.O. and/or N.C. Cutler-Hammer C383RLDG intelligent process interface single type poles rated at 6 AMP 120 V AC. The relays 36 include alarm equipment relays 36 a for shutting down a first set of controlled equipment and system discharge relays 36 b for shutting down a second set of controlled equipment. As used herein, “activating” of a relay means switching its state to cause the associated equipment to be shutdown. Thus, any type of logic may be applied without departing from the scope of the present invention. For example, a normally open relay may be energized to keep a circuit closed and upon activation by the PLCs 34, the normally open relay is deenergized to open up the circuit. The first set of equipment may include fire smoke dampers, magnetic door holders, and/or the AC or other HVAC equipment. The second set of equipment may include uninterruptible power supply units, power distribution units, and/or other power protection devices.

The EPSMS 10 also preferably includes one or more shunt trip relays 42 for shutting down a third set of controlled equipment connected to associated shunt trip circuit breakers. The third set of controlled equipment may include some or all of the second set of equipment and/or other equipment which could cause electrical shock or electrocution to a person.

The PLCs 34, relays 36, and display 38 are interconnected by wiring such as 16 gauge THHN stranded color black wiring. The wire may be routed in PANDUIT base duct slotted wall Panduit FIX2LG6 and covered with Panduit C1LG6. The EPSMS 10 may also include appropriate terminal blocks such as Cutler-Hammer screw type single level terminal blocks numbered with Cutler-Hammer identification labels.

All labels on the exterior of the enclosure 40 are preferably black plastic with white engraved letters, a minimum of ½″ high. All labels inside the enclosure are preferably P-Touch style. All relays and LEDs are labeled for their function. In one or more embodiments, the enclosure 40 comprises a box 41 with an opening 43 and a lid 45 hingedly connected to the box 41. The lid 45 defines a cut out 47 through which the touchscreen display can be accessed when the lid 45 is closed over the opening 43. In one or more embodiments, the touchscreen display 38 is attached to the lid 45 and connected to one or more of the PLCs 34 via a cable 49 having one or more data lines and one or more power lines, such as a CAT5 ethernet cable.

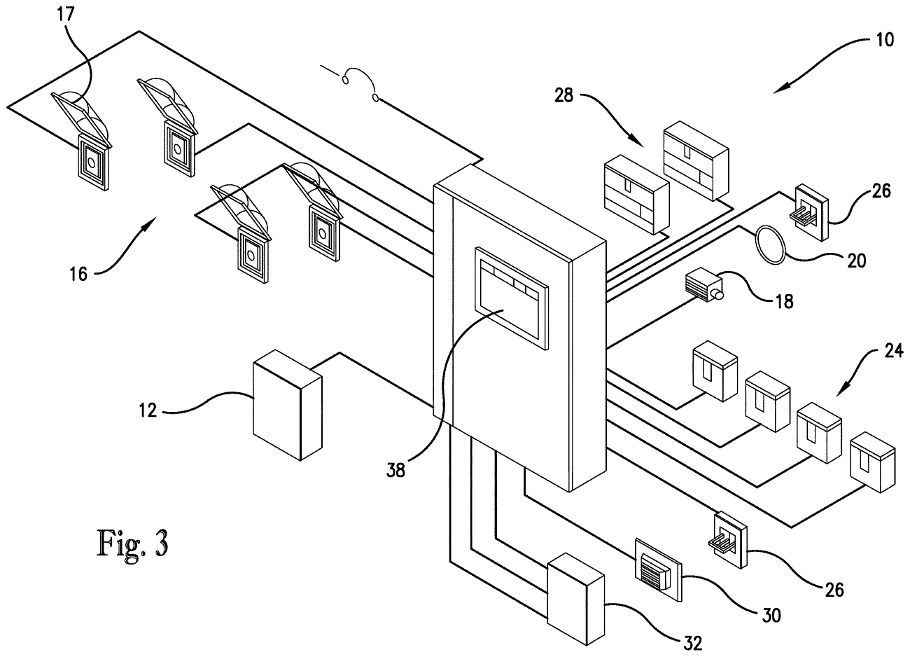

As best illustrated in FIG. 3, the EPSMS 10 maybe coupled with various input signal sources, controlled devices, and monitoring devices for consolidating, controlling, and monitoring the shut-down of the controlled devices. For example, the EPSMS 10 may receive input signals from a fire and clean agent control panel 12 and a plurality of emergency power off (EPO) switches or buttons 16. The controlled devices may include a fire/smoke damper 18, one or more electrically operated door holders 20, uninterruptible power supplies (UPS) 24, equipment connected to one or more shunt trip breakers 26, and air conditioning units 28. The monitoring devices may include a maintenance override beacon 30 and one or more remote or outside monitoring stations 32. The beacon 30 is for alerting nearby persons when the EPSMS 10 is switched to the maintenance mode. The beacon 30 is preferably located a minimum of three feet above the EPSMS panel 10 and is powered from the EPSMS control panel. The beacon 30 is activated when the maintenance override key switch is in the override (maintenance) position. These are just some of the examples of the devices which can be coupled with the EPSMS, as the present invention can be used with other input signal sources, controlled devices, and monitoring devices without departing from the scope of the claims.

The fire control panel 12 monitors fire or explosion detection equipment such as smoke detectors in a room or zone and provides an alarm signal to the EPSMS 10 upon detection of smoke, fire or an explosion by at least two of the detectors. The fire control panel 12 also starts a time delay countdown, such as a 30 second countdown, after receiving signals from two or more detectors and then triggers sprinklers, rupture discs or other devices to release fire or explosion suppression agents into the room or zone after the time delay countdown. At the same time, the fire control panel 12 provides a system discharge signal to the EPSMS 10.

The EPO switches 16 may be activated to immediately disconnect power to all electrically operated equipment in the room or zone and to shut down or disconnect all power delivery equipment for the room or zone. The EPO switches 16 also provide an EPO signal to the EPSMS 10 when activated. The EPO switches are preferably dual action keyed latching type switch. In one or more embodiments, one of more of the switches 16 include a cover 17 and a tamper sensor configured to detect when the cover 17 has been opened or tampered with and transmit a signal representative of the tampering of the corresponding switch to one or more of the PLCs 34.

The EPSMS 10 is connected to a suitable source of power such as a 120 VAC electricity source. Input power to the enclosure is protected by a breaker or fuse such as an internally mounted Cutler-Hammer 120 VAC 10-amp circuit breaker.

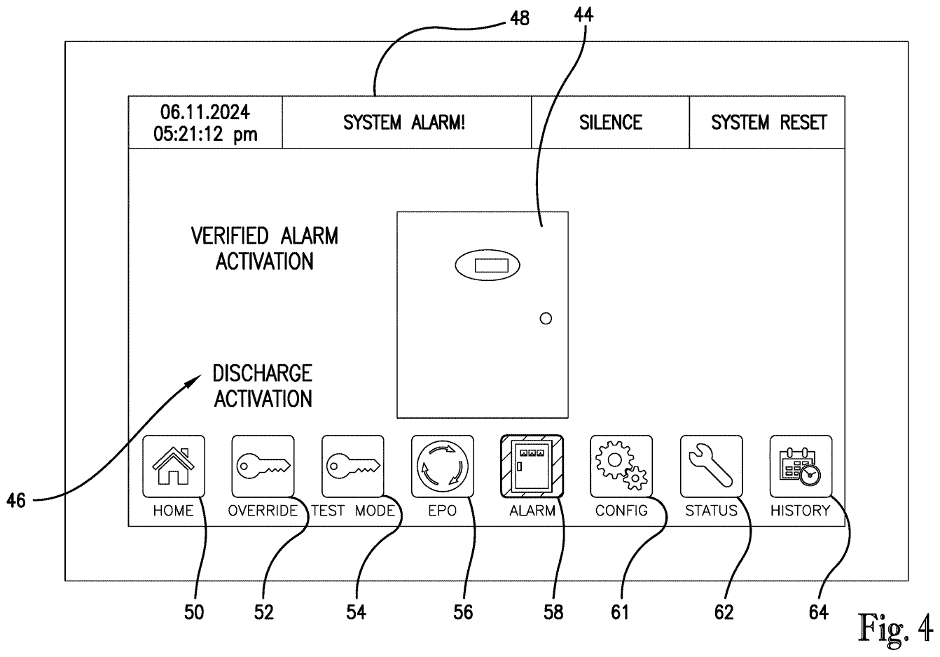

As best illustrated in FIG. 4, one or more of the PLCs 34 is configured to depict on the display 38 a number of indicators, such as icons, graphics, text, or the like. In one or more embodiments, one or more of the PLCs 34 are programmed to depict on the display 38 an alarm indicator 44, a system discharge indicator 46, and a status indicator 48. In one or more embodiments, the alarm indicator 44 is for indicating activation of the alarm, such as an indication that one or more inputs sent a signal representative of a fire detection to one or more of the PLCs 34. The system discharge indicator 46 is for indicating the discharge of fire or explosion suppression agents. The status indicator 48 indicates the present status of the EPSMS 10.

In one or more embodiments, one or more of the PLCs 34 may also be programmed to depict on the display 38 a menu of icons representative of different pages of the user interface. For example, one of the icons may include a home screen icon 50, an override icon 52, a test mode icon 54, an EPO switch icon 56, an alarm icon 58, a configurations icon 61, a status icon 62, and an event history icon 64.

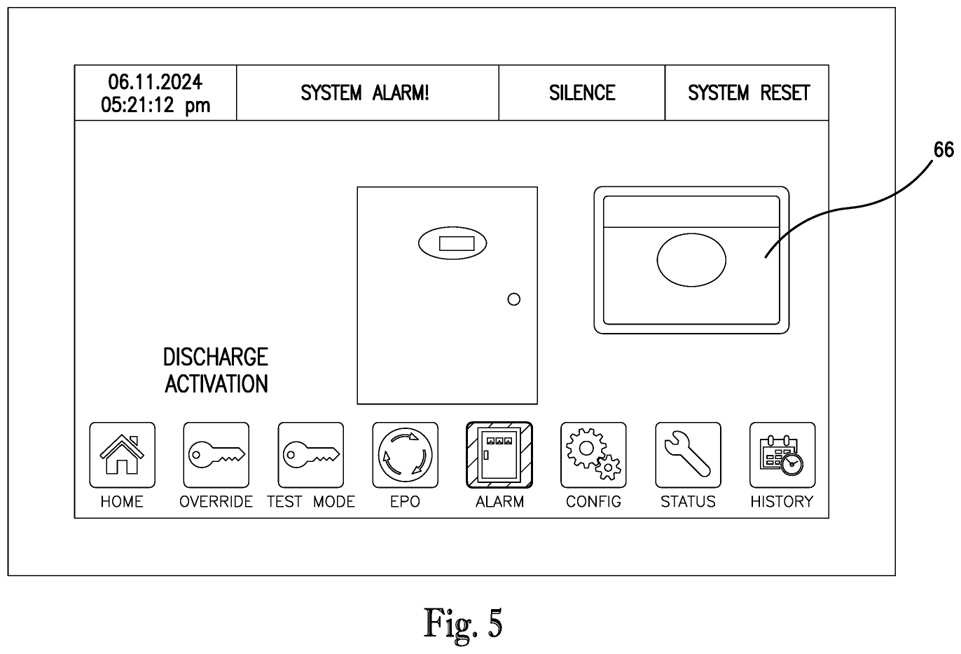

As best illustrated in FIG. 5, in one or more embodiments, the one or more of the PLCs 34 may also be programmed to depict on the display 38 an abort button 66. One or more of the PLCs 34 is programmed to impose a predefined time delay upon receipt of the system discharge signal from the fire control panel before activating the system discharge relays and shutting down the second set of equipment. The PLCs 34 may be programmed to receive via the touchscreen display an input representative of an instruction to abort, such as through the abort button 66. The PLC may then terminate the time delay and not activate the system discharge relays or shut down the second set of equipment. The PLCs 34 may also be programmed to depict on the display 38 an amount of time remaining in the delay or countdown.

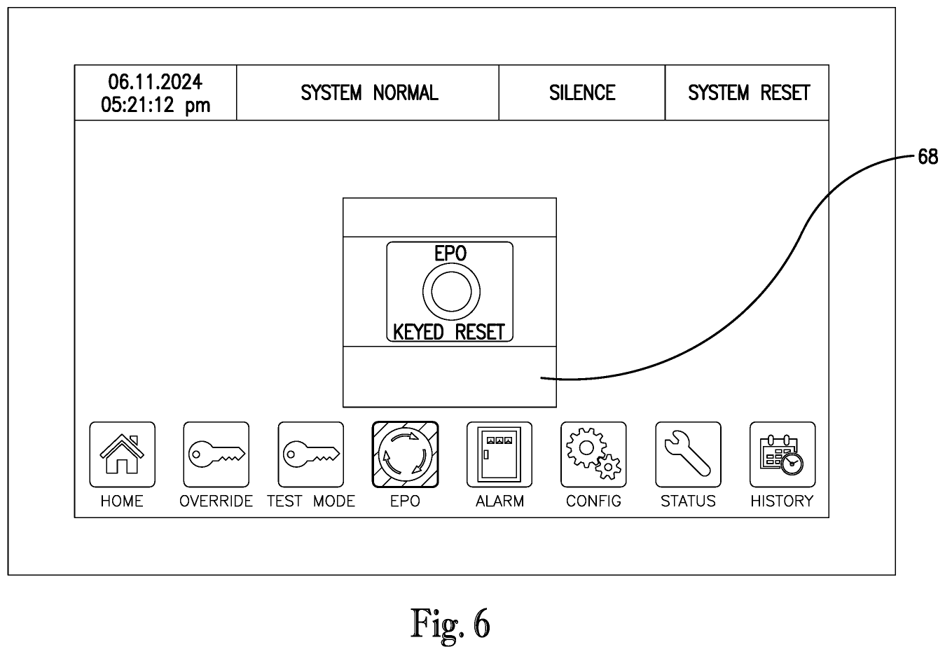

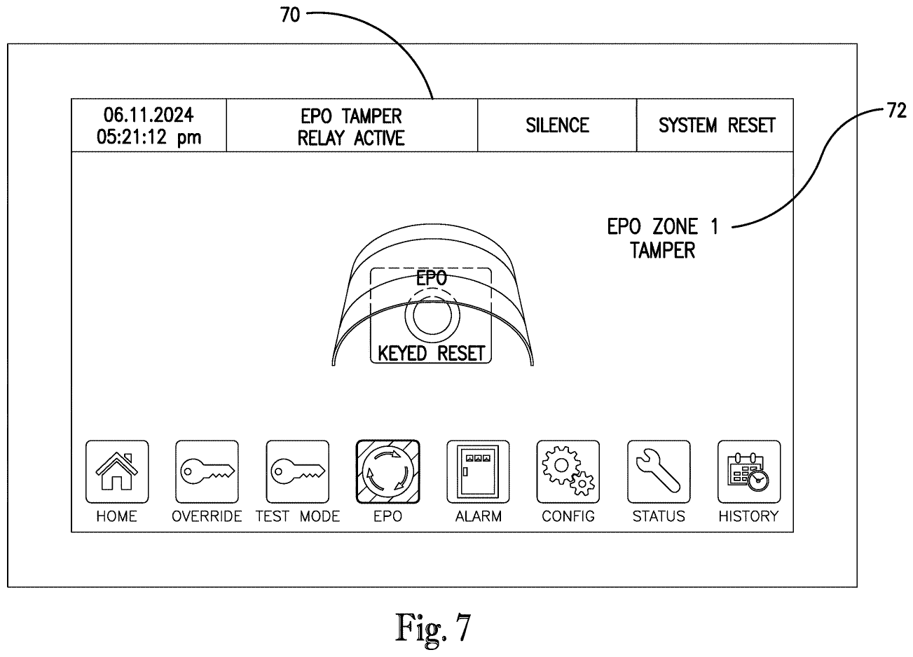

As best illustrated in FIG. 6, the display 38 is also operable to display one or more EPO indicators 68 for indicating an emergency power off situation upon receipt of an EPO signal from one or more of the plurality of EPO switches 16. As best illustrated in FIG. 7, in one or more embodiments, the display 38 is also operable to display a tamper indication 70, such as when the lid of one of the EPO switches is opened, and the tamper sensor sends a tamper signal to one or more of the PLCs 34. The display 38 may also display an identification 72 of the EPO switch that was opened or tampered.

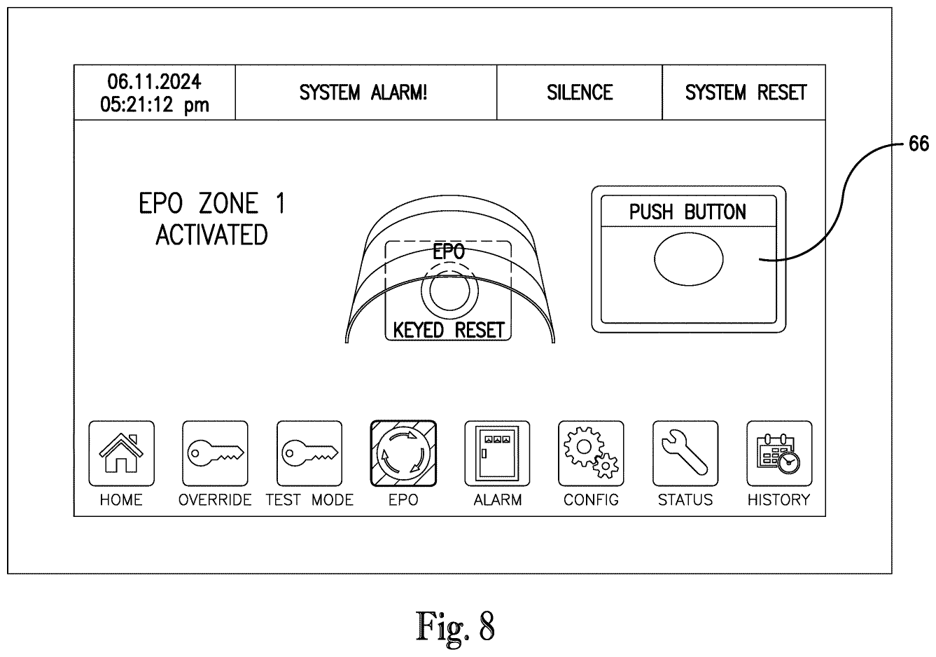

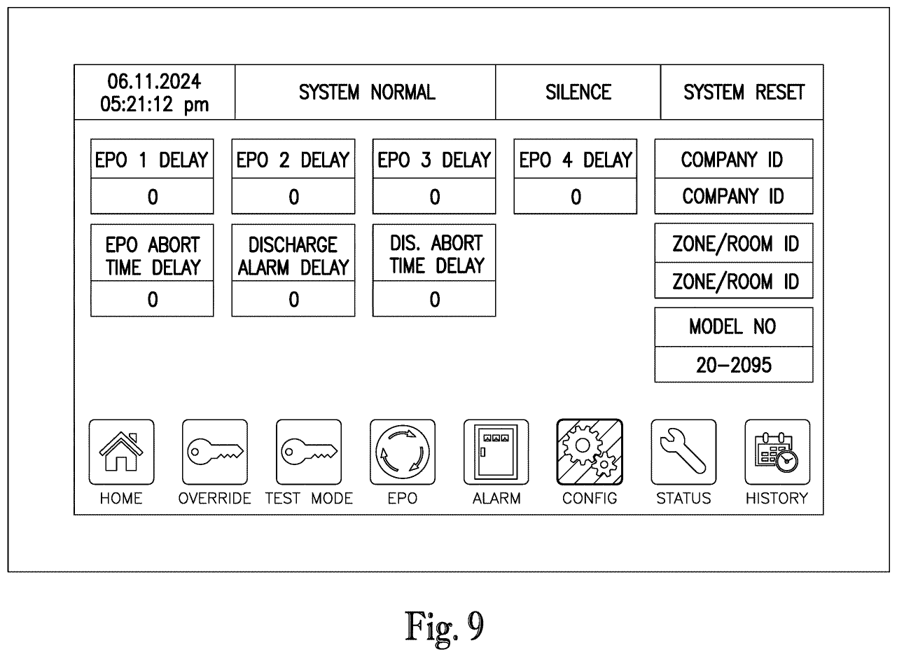

As best illustrated in FIG. 8, in one or more embodiments, one or more of the PLCs 34 is programmed to impose a predefined time delay upon receipt of the emergency power off signal before activating the alarm equipment relays, the system discharge relays, and the shunt trip relays and shutting down the first, second, and third sets of equipment. For example, when an EPO switch has been activated or pressed, the abort button 66 may be depicted on the display. One or more of the PLCs 34 is programmed to receive via the touchscreen display an input representative of an instruction to abort, such as by touching the abort button 66 on the display. The PLC 34 may then terminate the time delay, and not activate the alarm equipment relays, the system discharge relays, and the shunt trip relays or shut down the first, second, and third sets of equipment. As best illustrated in FIG. 9, the predefined time delay may be different depending on from which of the plurality of emergency power off switches the emergency power off signal was received.

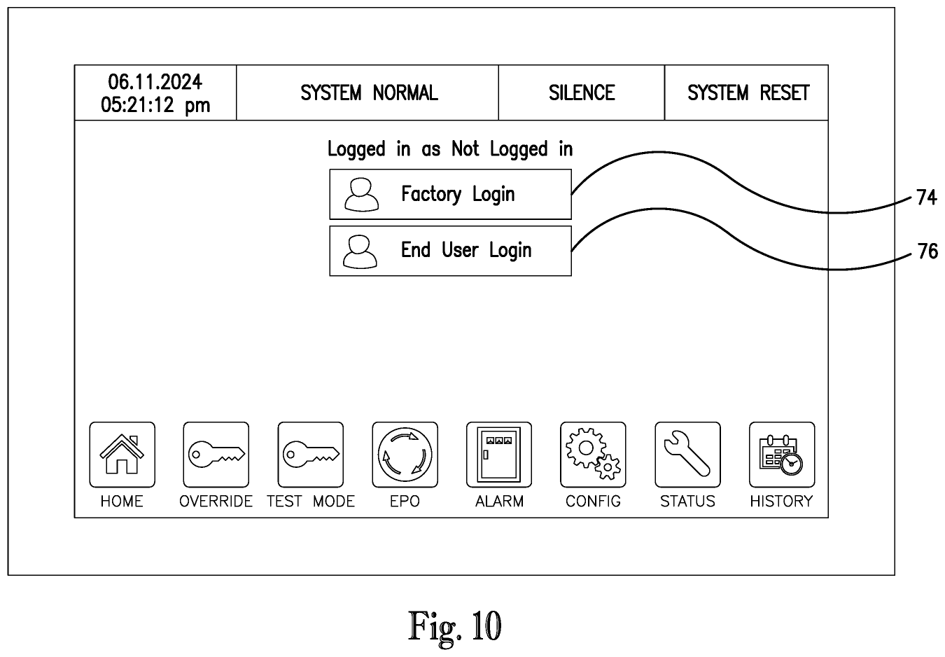

As best illustrated in FIG. 10, one or more of the PLCs 34 is programmed to store on the one or more memory element an administrator or factory set of settings and a user set of settings. One or more of the PLCs 34 is programmed to provide access to the administrator set of settings and the user set of settings upon receipt of an administrator/factory password by touching the factory login button 74 on the display and entering the administrator/factory password through the touchscreen display. One or more of the PLCs 34 is programmed to provide access to the user set of settings upon receipt of a user password by touching the end user login button 76 on the display and entering the end user password through the touchscreen display.

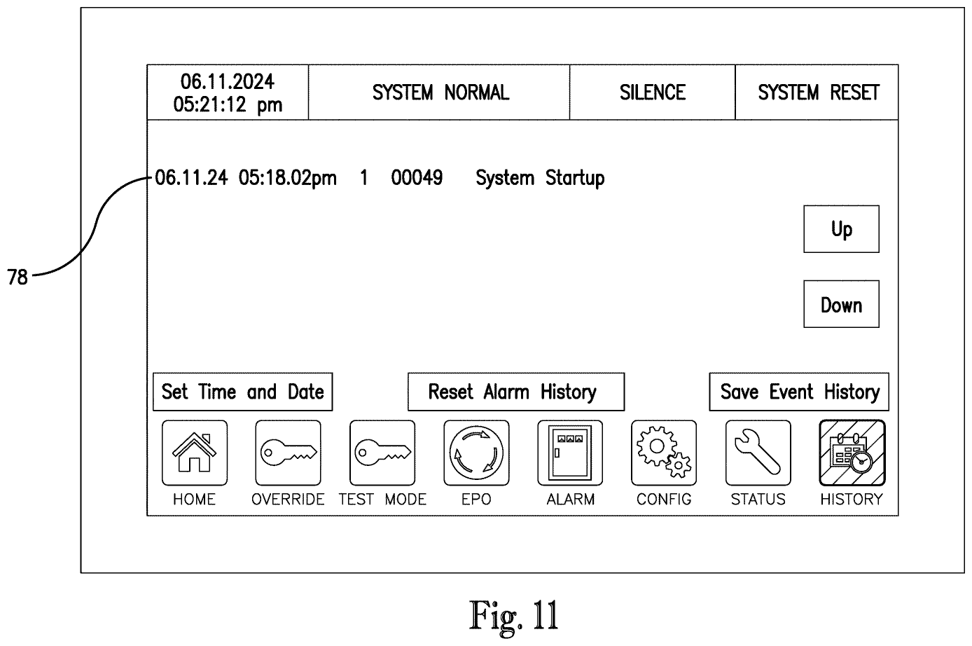

As best illustrated in FIG. 11, one or more of the PLCs 34 is programmed to record on the one or more memory element a date and time of a predefined event. The predefined event includes at least one of a system startup, a login attempt, a change of settings, a change of mode of the system, receipt of the signal representative of the alarm signal from the fire control panel, or receipt of the system discharge signal from the fire control panel. One or more of the PLCs 34 may be programmed to record on the one or more memory element an identification of the one or more of the plurality of EPO switches. The predefined event may also include a receipt of a signal representative of tampering of an enclosure at one or more of the plurality of emergency power off switches. Additionally, one or more of the PLCs 34 may be programmed to display on the touchscreen display data 78 associated with each event, including the identification of the triggered EPO switch. The data may include the date and time that the event occurred.

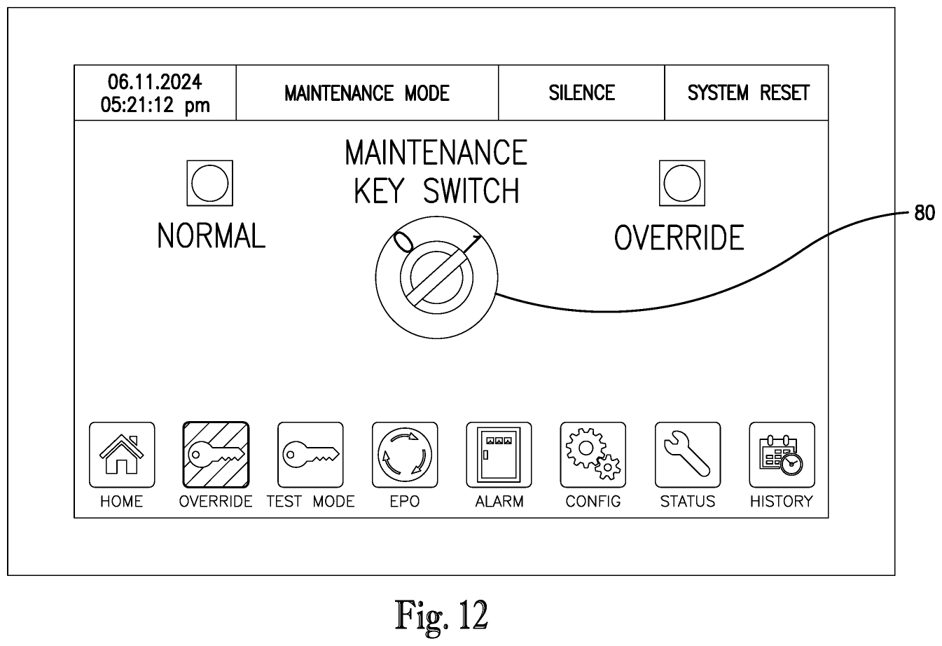

As best illustrated in FIG. 12, the display may be operable to display a maintenance override switch 80. The override switch 80 may be pressed to switch states between normal mode and maintenance override mode in which the EPSMS 10 is disabled, thereby preventing it from shutting any equipment down regardless of any input signals the EPSMS receives. One or more of the PLCs 34 may also activate the beacon 30. However, the system trouble relays remain active.

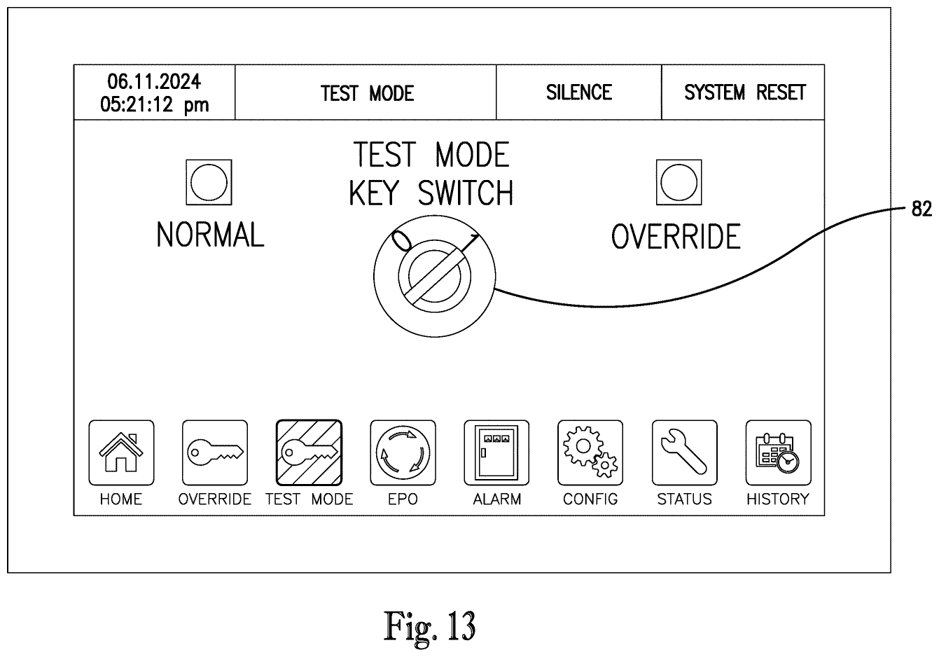

As best illustrated in FIG. 13, the display may be operable to display a test mode switch 82. The test mode switch 82 may be pressed to switch states between normal mode and test mode in which the EPSMS 10 in which the alarm and discharge relays are bypassed and inactive and one or more of the PLCs 34 is programmed to display on the touchscreen display graphics representative of a detected event while in test mode. In one or more embodiments, one or more of the PLCs 34 is programmed to return the EPSMS 10 to normal mode after a predefined amount of time with no inputs received at the touchscreen display. The predetermined time may be, for example, 60 minutes. In one or more embodiments, test mode is substantially the same as override mode with a few exceptions. While in test mode, the EPO activated and EPO tamper monitoring relays activate when an EPO button is activated or an EPO tamper exists. The trouble relay does not de-energize. The override beacon 30 does not illuminate when in test mode, and a piezo alert does not sound.

By controlling the several relays through the PLCs 34, controls are consolidated in one location. Additionally, the PLCs 34 can record event history on the memory element for all critical system functions, troubles, and alarms. The PLCs 34 and display 38 enable a maintenance bypass mode with lockout to prevent accidental activation of emergency power off when removing the system 10 from override mode. Additionally, the PLCs 34 are programmed to implement staged activation of critical power and HVAC and other mechanical system shutdown. Embodiments also enable thorough documentation and sequence of operation. The touchscreen display enables clear signage and drawings of the entire control system. It also enables local monitoring and display of functions. One or more embodiments may include dual action locking-type EPO switches with protective flip-up covers. In one or more embodiments, the PLCs 34 also enable remote monitoring of relays of critical functions. In one or more embodiments, power to the system 10 can be monitored by a fire control panel, as required by NFPA 75. The touchscreen display further enables modularity so that the system can be modified or expanded, such as to include additional connections to EPO switches located in different zones.

### Operation

The EPSMS 10 may be installed and operated in any room, zone or other area which is protected by a fire or explosion control system. The EPSMS 10 is preferably assembled and bench tested to verify proper operation prior to delivery to the job site. In normal operation, the status indicator 48 is displayed as normal, the maintenance override and test mode switches 80, 82 are display in the normal position with normal graphics displayed.

When the fire control panel 12 detects fire, smoke, or an explosion with at least two detectors, it generates an alarm signal and sends it to an input of the PLC 34. The PLC 34 activates the alarm indicator 44 and the alarm equipment relays 36 a upon receipt of the alarm signal. The relays 36 a then shut down the first set of equipment described above to prepare the protected room or zone for the imminent dispersion of fire or explosion suppression agents into the room or zone.

After the fire control panel 12 has completed the time delay countdown described above, it generates a system discharge signal and sends it to an input of the PLC 34. The PLC displays the system discharge indicator 46 on the display 38 and activates the system discharge relays 36 b upon receipt of the system discharge signal. The relays 36 b then shut down the second set of equipment described above to prevent equipment damage and shock hazards due to release of the suppression agents.

Whenever a person activates one of the EPO switches, an EPO signal is sent to an input of the PLC 34. The EPO switch may be activated by a person, for example, when another person accidentally contacts a short circuit or other electrical hazard and is in danger of being electrocuted. Upon receipt of the EPO signal, the PLC displays the emergency power off indicator 68 on the display 38 and activates the alarm equipment relays 36 a, the system discharge relays 36 b, and the shunt trip relays 42. The relays 36 a, 36 b, and 42 then shut down the first, second, and third sets of equipment. The shunt trip relays 42 are preferably only activated for five seconds to prevent electrical damage to the coils of the associated shunt trip breakers.

When the maintenance override key switch 80 is pressed to switch the EPSMS 10 to the override mode, the maintenance override key switch 80 is displayed in the override mode and the status indicator 48 displays override mode. The alarm and discharge shutdown relays 36 a, 36 b remain in normal position and cannot be energized regardless of any input signal received by the PLC 34. When the EPSMS 10 is in override, if any input signal is received, the appropriate alarm indicator 44, discharge indicator 46, and/or EPO indicator 68 is displayed, but no equipment is shut down.

When the test mode switch 82 is pressed to switch the EPSMS 10 to the test mode, the test mode switch 82 is displayed in the test mode and the status indicator 48 displays test mode. The EPO switches and tamper sensors will still be monitored, and the EPO relays will still be active.

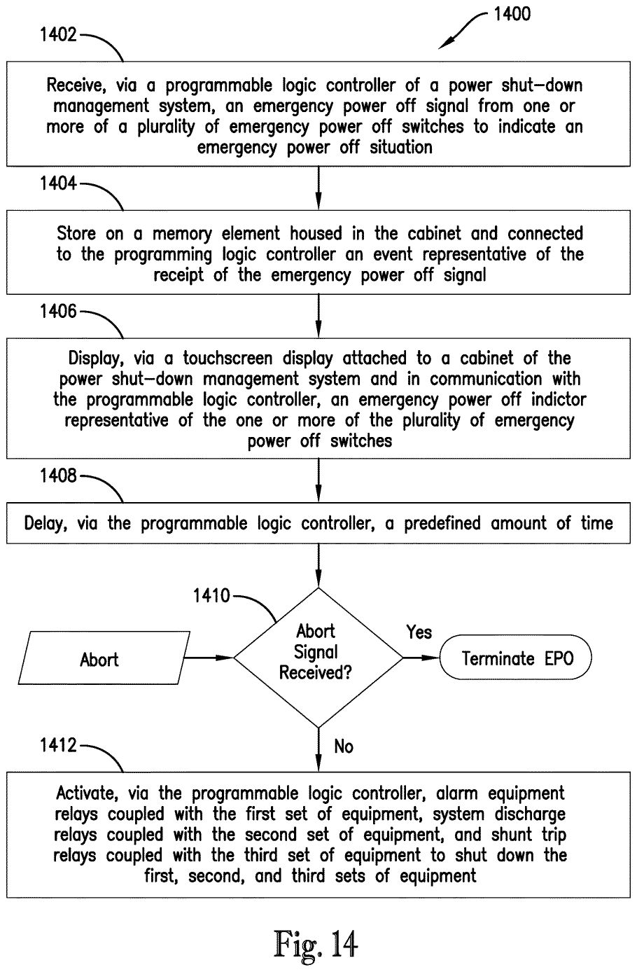

The flow chart of FIG. 14 depicts the steps of an exemplary method 1400 of controlling a shutdown of first, second, and third sets of equipment. In some alternative implementations, the functions noted in the various blocks may occur out of the order depicted in FIG. 14. For example, two blocks shown in succession in FIG. 14 may in fact be executed substantially concurrently, or the blocks may sometimes be executed in the reverse order depending upon the functionality involved. In addition, some steps may be optional.

The method 1400 is described below, for ease of reference, as being executed by exemplary devices and components introduced with the embodiments illustrated in FIGS. 1-13. The steps of the method 1400 may be performed by the PLC through the utilization of processors, transceivers, hardware, software, firmware, or combinations thereof. However, some of such actions may be distributed differently among such devices or other devices without departing from the spirit of the present invention. Control of the system may also be partially implemented with computer programs stored on one or more non-transient computer-readable medium(s). The computer-readable medium(s) may include one or more executable programs stored thereon, wherein the program(s) instruct one or more processing elements to perform all or certain of the steps outlined herein. The program(s) stored on the computer-readable medium(s) may instruct processing element(s) to perform additional, fewer, or alternative actions, including those discussed elsewhere herein.

Referring to step 1402, an EPO signal is received at one or more of the PLCs. The EPO signal may be received from one or more of the plurality of EPO switches to indicate an emergency power off situation. The PLCs may be programmed to identify the EPO switch based on which input port of the PLCs received the signal. This step may also include first receiving at the PLCs a tamper signal from the corresponding tamper sensor. This step may also include displaying the tamper indicator when the tamper signal was received.

Referring to step 1404, an event representative of the receipt of the EPO signal is stored on the memory element via one or more of the PLCs. This step may include storing the time and date of the receipt of the EPO signal as well as an identification of the EPO switch from which the signal was received. This step may also include storing the date and time that the tamper signal was received, as well as an identification of the tampered EPO switch.

Referring to step 1406, the EPO indictor representative of the one or more of the plurality of EPO switches is displayed on the touchscreen display via one or more of the PLCs. This step may also include displaying on the touchscreen display via one or more of the PLCs the status indicator as being in an alarm state. This step may also include displaying on the touchscreen display via the one or more PLCs the abort button and/or a countdown of remaining time if the system is configured with a delay.

Referring to step 1408, a predefined amount of time is passed via the PLCs.

Referring to step 1410, if an abort input has been received at the touchscreen display and transmitted to the PLC, then the EPO is terminated. The abort input may be received when a user touches the touchscreen display where the abort button is display. In one or more embodiments, the abort signal must be received within the delay period to terminate the EPO.

Referring to step 1412, the alarm equipment relays coupled with the first set of equipment, the system discharge relays coupled with the second set of equipment, and the shunt trip relays coupled with the third set of equipment are activated, via one or more of the PLCs, to shut down the first, second, and third sets of equipment. This step may not be executed if the abort signal was received within the delay period.

The method 1400 may include additional, less, or alternate steps and/or device(s), including those discussed elsewhere herein.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than or equal to about 10” (with no upper bounds) and a claim reciting “less than or equal to about 100” (with no lower bounds).

Furthermore, unless otherwise specified, any directional references (e.g., upper, lower, above, below, etc.) are used herein solely for the sake of convenience and should be understood only in relation to each other. For instance, a component might in practice be oriented such that faces referred to as “upper” and “lower” are sideways, angled, inverted, etc. relative to the chosen frame of reference.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element (including the PLCs), may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element”, PLC, or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

The EPSMS may additionally or alternatively include processors, microprocessors (single-core and multi-core), microcontrollers, DSPs, field-programmable gate arrays (FPGAs), analog and/or digital application-specific integrated circuits (ASICs), or the like, or combinations thereof. The processing element may generally execute, process, or run instructions, code, code segments, software, firmware, programs, applications, apps, processes, services, daemons, or the like. The processing element may also include hardware components such as finite-state machines, sequential and combinational logic, and other electronic circuits that can perform the functions necessary for the operation of the current invention. The processing element may be in communication with the other electronic components through serial or parallel links that include address busses, data busses, control lines, and the like.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The memory device or element may include data storage components, such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element may be embedded in, or packaged in the same package as, the processing element. The memory element may include, or may constitute, a “computer-readable medium”. The memory element may store the instructions, code, code segments, software, firmware, programs, applications, apps, services, daemons, or the like that are executed by the processing element.

The communication element may generally allow communication with systems and/or external devices. The communication element may include signal or data transmitting and receiving circuits, such as antennas, amplifiers, filters, mixers, oscillators, digital signal processors (DSPs), and the like. The communication element may establish communication wirelessly by utilizing RF signals and/or data that comply with communication standards such as cellular 2G, 3G, 4G, 5G, or LTE, WiFi, WiMAX, Bluetooth®, BLE, or combinations thereof. The communication element may be in communication with the processing element and the memory element.

The user interface of the touchscreen display generally allows the user to utilize inputs and outputs to interact with the device and is in communication with the one or more processing element. Inputs may additionally or alternatively include buttons, pushbuttons, knobs, jog dials, shuttle dials, directional pads, multidirectional buttons, switches, keypads, keyboards, mice, joysticks, microphones, or the like, or combinations thereof. The outputs of the present invention may include the display and/or any number of additional outputs, such as audio speakers, lights, dials, meters, printers, or the like, or combinations thereof, without departing from the scope of the present invention.

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A power shut-down management system for consolidating, controlling, and monitoring the shut-down of electrically powered equipment, the system comprising:
a plurality of alarm equipment relays coupled with a first set of equipment;
a plurality of system discharge relays coupled with a second set of equipment;
a plurality of shunt trip relays coupled with a third set of equipment;
a cabinet for housing the one or more alarm equipment relays, the system discharge relays, and the shunt trip relays;
a touchscreen display positioned on the cabinet; and
a programmable logic controller housed in the cabinet and in communication with the touchscreen display, the programmable logic controller being programmed to:
display on the touchscreen display an alarm indicator for indicating activation of an alarm, a system discharge indicator for indicating a discharge of fire or explosion suppression agents, and a plurality of emergency power off indicators for indicating an emergency power off situation in one or more of a plurality of zones,
activate the alarm indicator and the plurality of alarm equipment relays upon receipt of a signal representative of an alarm signal from a fire control panel to indicate the activation of the alarm and to shut down the first set of equipment,
activate the system discharge indicator and the system discharge relays upon receipt of a system discharge signal from the fire control panel to indicate the discharge of fire or explosion suppression agents and to shut down the second set of equipment, and
activate the plurality of emergency power off indicators, the alarm equipment relays, the system discharge relays, and the shunt trip relays upon receipt of an emergency power off signal from one or more of a plurality of emergency power off switches to indicate the emergency power off situation and to shut down the first, second, and third sets of equipment.

2. The system of claim 1, further comprising one or more memory element housed in the cabinet and in communication with the programmable logic controller, wherein the programmable logic controller is programmed to record on the one or more memory element a date and time of a predefined event.

3. The system of claim 2, wherein the predefined event includes receipt of the emergency power off signal, and the programmable logic controller is programmed to record on the one or more memory element an identification of the one or more of the plurality of emergency power off switches.

4. The system of claim 3, wherein the programmable logic controller is programmed to display on the touchscreen display the identification.

5. The system of claim 3, wherein the predefined event includes receipt of a signal representative of tampering of an enclosure at one or more of the plurality of emergency power off switches.

6. The system of claim 2, wherein the programmable logic controller is programmed to store on the one or more memory element an administrator set of settings and a user set of settings, provide access to the administrator set of settings and the user set of settings upon receipt of an administrator password, and provide access to the user set of settings upon receipt of a user password.

7. The system of claim 2, wherein the predefined event includes at least one of a system startup, a login attempt, a change of settings, a change of mode of the system, receipt of the signal representative of the alarm signal from the fire control panel, or receipt of the system discharge signal from the fire control panel.

8. The system of claim 1, wherein the programmable logic controller is programmed to impose a predefined time delay upon receipt of the emergency power off signal before activating the alarm equipment relays, the system discharge relays, and the shunt trip relays and shutting down the first, second, and third sets of equipment.

9. The system of claim 8, wherein the programmable logic controller is programmed to:
receive via the touchscreen display an input representative of an instruction to abort,
terminate the time delay, and
not activate the alarm equipment relays, the system discharge relays, and the shunt trip relays or shut down the first, second, and third sets of equipment.

10. The system of claim 8, wherein the predefined time delay is different depending on from which of the plurality of emergency power off switches the emergency power off signal was received.

11. The system of claim 1, wherein the programmable logic controller is programmed to impose a predefined time delay upon receipt of the system discharge signal from the fire control panel before activating the system discharge relays and shutting down the second set of equipment.

12. The system of claim 11, wherein the programmable logic controller is programmed to:
receive via the touchscreen display an input representative of an instruction to abort,
terminate the time delay, and
not activate the system discharge relays or shut down the second set of equipment.

13. The system of claim 1, wherein the cabinet comprises a box with an opening and a lid hingedly connected to the box, the lid defining a cut out through which the touchscreen display can be accessed when the lid is closed over the opening.

14. The system of claim 13, wherein the touchscreen display is attached to the lid, and the touchscreen display is connected to the programmable logic controller via a cable having one or more data lines and one or more power lines.

15. The system of claim 1, wherein the programmable logic controller is programmed to receive, via the touchscreen display, an input representative of a test mode selection, and while in test mode, the programmable logic controller is programmed to not activate the alarm equipment relays, the system discharge relays, the shunt trip relays, or shut down the first, second, or third sets of equipment.

16. The system of claim 15, wherein the programmable logic controller is programmed to return to a normal mode after a predefined amount of time with no inputs received at the touchscreen display.

17. The system of claim 15, wherein the programmable logic controller is programmed to display on the touchscreen display graphics representative of a detected event while in test mode.

18. A method of controlling a shutdown of first, second, and third sets of equipment, the method comprising:
receiving, via a programmable logic controller of a power shut-down management system, an emergency power off signal from one or more of a plurality of emergency power off switches to indicate an emergency power off situation;
displaying, via a touchscreen display attached to a cabinet of the power shut-down management system and in communication with the programmable logic controller, an emergency power off indictor representative of the one or more of the plurality of emergency power off switches;
delaying, via the programmable logic controller, a predefined amount of time; and
activating, via the programmable logic controller, alarm equipment relays coupled with the first set of equipment, system discharge relays coupled with the second set of equipment, and shunt trip relays coupled with the third set of equipment to shut down the first, second, and third sets of equipment.

19. The method of claim 18, further comprising storing on a memory element housed in the cabinet and connected to the programming logic controller an event representative of the receipt of the emergency power off signal.
